(19) United States
(12) Patent Application Publication
(10) Pub. No.: US 2017/0099770 A1
(43) Pub. Date: Apr. 13, 2017

(54) MOWER WITH SHOCK ABSORBERS

(71) Applicant: Mark Lucas Badovinac, II, Cedar Springs, MI (US)

(72) Inventor: Mark Lucas Badovinac, II, Cedar Springs, MI (US)

(21) Appl. No.: 15/291,534

(22) Filed: Oct. 12, 2016

Related U.S. Application Data
(60) Provisional application No. 62/240,200, filed on Oct. 12, 2015.

(51) Int. Cl. A01D 34/74; A01D 34/86

(52) U.S. Cl. CPC A01D 34/74; A01D 34/86; A01D 2101/00

(57) ABSTRACT

A mower with reduced noise and vibrations is provided. The mower includes a mower frame and at least one drive motor supported by the mower frame. A plurality of wheels support the mower frame. At least one of the plurality of wheels is driven by the at least one motor. A cutting deck assembly hangs from the mower frame by a plurality of chain links. The cutting deck assembly includes a cutting deck and at least one cutting blade mounted under the cutting deck and rotatable by the at least one drive motor. At least one shock absorber has a first end opposite a second end. The first end is secured to the mower frame and the second end is secured to the cutting deck.

### CROSS-REFERENCE TO RELATED APPLICATION

This application claims the benefit of priority of U.S. provisional application No. 62/240,200, filed Oct. 12, 2015, the contents of which are herein incorporated by reference.

### BACKGROUND OF THE INVENTION

The present invention relates to a riding lawn mower and, more particularly, to a riding lawn mower with shock absorbers.

Current mowers include a cutter deck attached to mower frames by lift links. When cutter decks go over uneven terrain or when the support carrying the deck experiences shock loads, the cutter deck may free fall back to its original position, which is loud and unpleasant for the rider.

As can be seen, there is a need for a mower that reduces the fall speeds of displaced cutter decks.

### SUMMARY OF THE INVENTION

In one aspect of the present invention, a mower comprises: a mower frame; at least one drive motor supported by the mower frame; a plurality of wheels supporting the mower frame, wherein at least one of the plurality of wheels is driven by the at least one drive motor; a cutting deck assembly hanging from the mower frame by a plurality of chain links, the cutting deck assembly comprising a cutting deck and at least one cutting blade mounted under the cutting deck and rotatable by the at least one drive motor; and at least one shock absorber comprising a first end opposite a second end, wherein the first end is secured to the mower frame and the second end is secured to the cutting deck.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use on an exemplary mower;

FIG. 2 is a top view of an embodiment of the present invention;

FIG. 3 is an exploded view of an embodiment of the present invention;

FIG. 4 is a side view of an embodiment of the present invention;

FIG. 5 is a side view of the present invention illustrating an alternate placement of the shock absorber; and

FIG. 6 is a side view of the present invention illustrating an alternate placement of the shock absorber.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a mower deck shock absorbing system. The present invention reduces or eliminates the shock load produced by the uncontrolled motion of mower decks and lift linkage as felt by the operator and/or machine. The present invention includes a shock absorber (fluid/friction etc.) or motion controlling device installed between the deck and the frame of the deck carrying device, the frame and the lift/positioning linkage, the lift/positioning linkage and the deck to attenuate the quick motions of the deck. The shock absorbing device is calibrated to allow quick but controlled motion up (thus eliminating undue strain and allowing the mower deck and/or lift/positioning linkage to travel up quickly without transmitting force to the deck carrying device) and then lowering the mower deck back down to the correct height in a controlled manner.

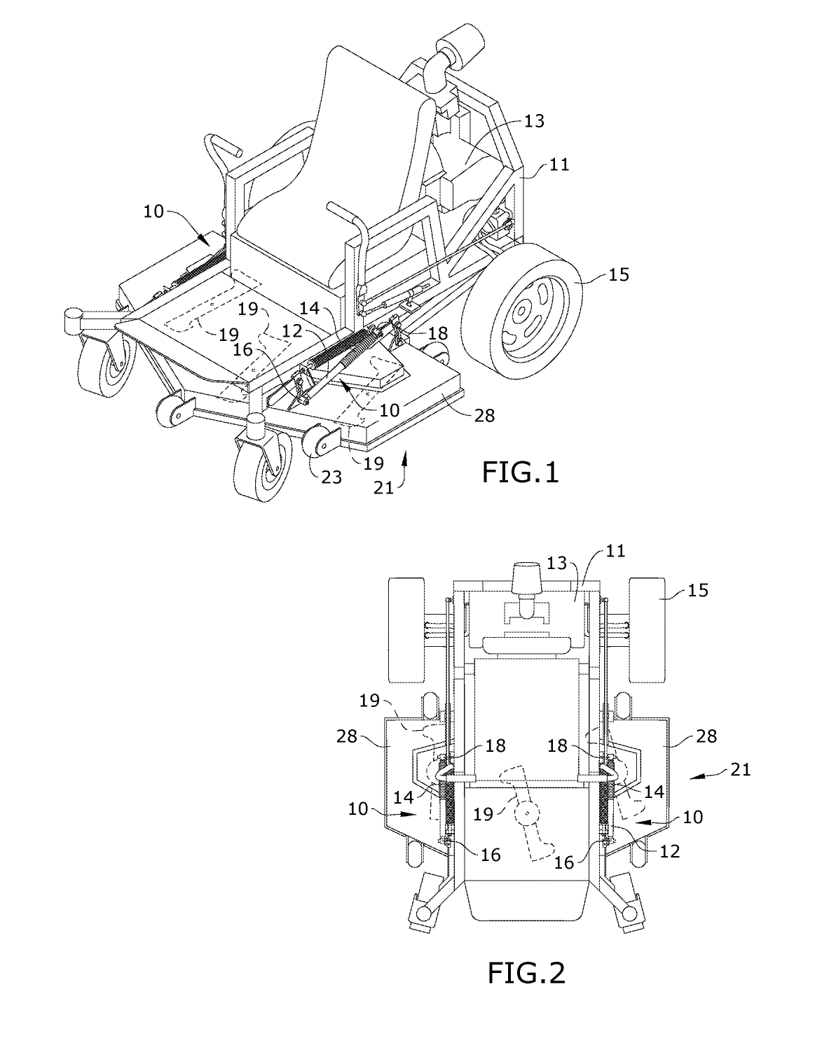

Referring to FIGS. 1 through 6, the present invention includes a mower. The mower includes a mower frame 11 and at least one drive motor 13 supported by the mower frame 11. A plurality of wheels 15 support the mower frame 11. At least one of the plurality of wheels 15 is driven by the at least one motor 13. A cutting deck assembly 21 hangs from the mower frame 11 by a plurality of chain links 17. The cutting deck assembly 21 includes a cutting deck 28 and at least one cutting blade 19 mounted under the cutting deck 28 and rotatable by the at least one drive motor 13. At least one shock absorber 10 has a first end 18 opposite a second end 16. The first end 18 is secured to the mower frame 11 and the second end 28 is secured to the cutting deck 28.

In certain embodiments, the at least one shock absorber 10 includes a first shock absorber 10 secured to a first side of the mower frame 11 and the cutting deck 28 and a second shock absorber 10 secured to a second side of the mower frame 11 and the cutting deck 28. Each shock absorber 10 may include a piston 12 and a baffle 14. The shock absorber 10 is one of a mechanical shock absorber and a hydraulic shock absorber. The hydraulic absorber may be a two tube shock absorber, which includes two nested cylindrical tubes, an inner tube that is called the “working tube” or the “pressure tube”, and an outer tube called the “reserve tube”. At the bottom of the device on the inside is a compression valve or base valve. When the piston is forced up or down by bumps, hydraulic fluid moves between different chambers via small holes or “orifices” in the piston and via the valve, converting the “shock” energy into heat which must then be dissipated. When a user is mowing over a bump on the ground, as opposed to the cutting deck 28 slamming back down, the shock absorber 10 slowly lowers the cutting deck 28 back to its original position.

The cutting deck assembly 21 may further include a plurality of cutting deck wheels 23. In certain embodiments, the chain links 17 are secured to the mower frame 11 by pivoting arms 29. In certain embodiments, the first end 18 of the shock absorber 10 is secured to one of the pivoting arms 29 and the second end 16 of the shock absorber 10 is secured to a top surface of the cutting deck 28.

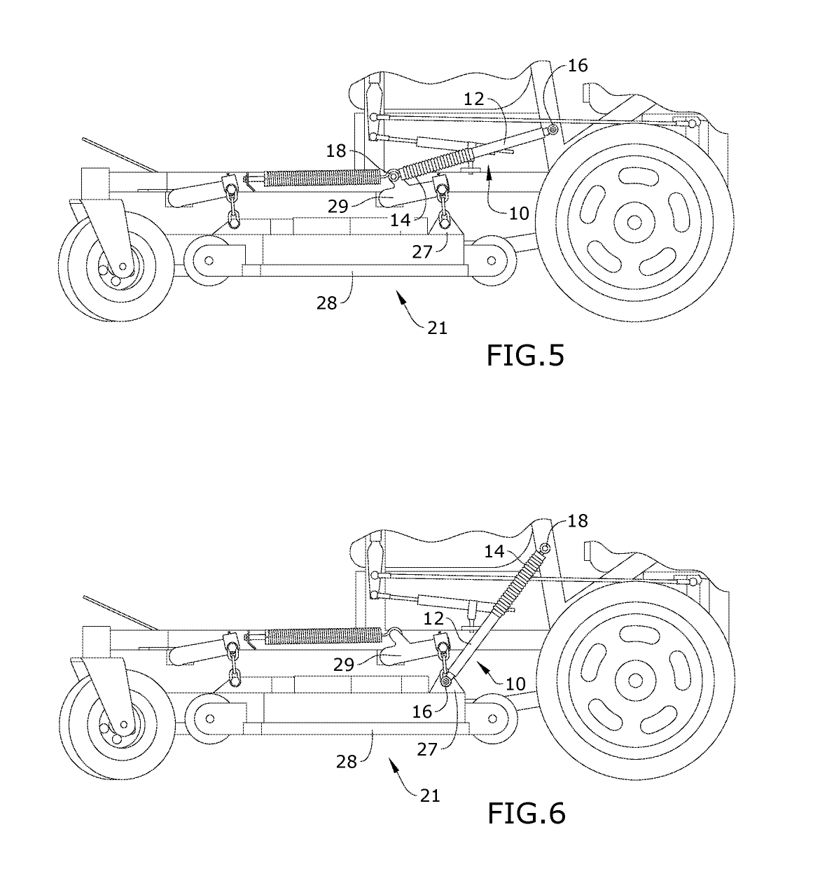

In certain embodiments, the plurality of chain links 17 includes a pair of front chain links 17 secured to front flanges 25 of the cutting deck 28 and a pair of rear chain links 17 secured to rear flanges 27 of the cutting deck 28. As illustrated in FIG. 4, the second end 16 of the shock absorber 10 is secured to one of the front flanges 25. As illustrated in FIG. 6, the second end 16 of the shock absorber 10 may be secured to one of the rear flanges 27. As illustrated in FIG. 5, the second end 16 of the shock absorber 10 may be secured to one of the pivot arms 29 and the first end 18 of the shock absorber 10 may be secured to the mower frame 11.

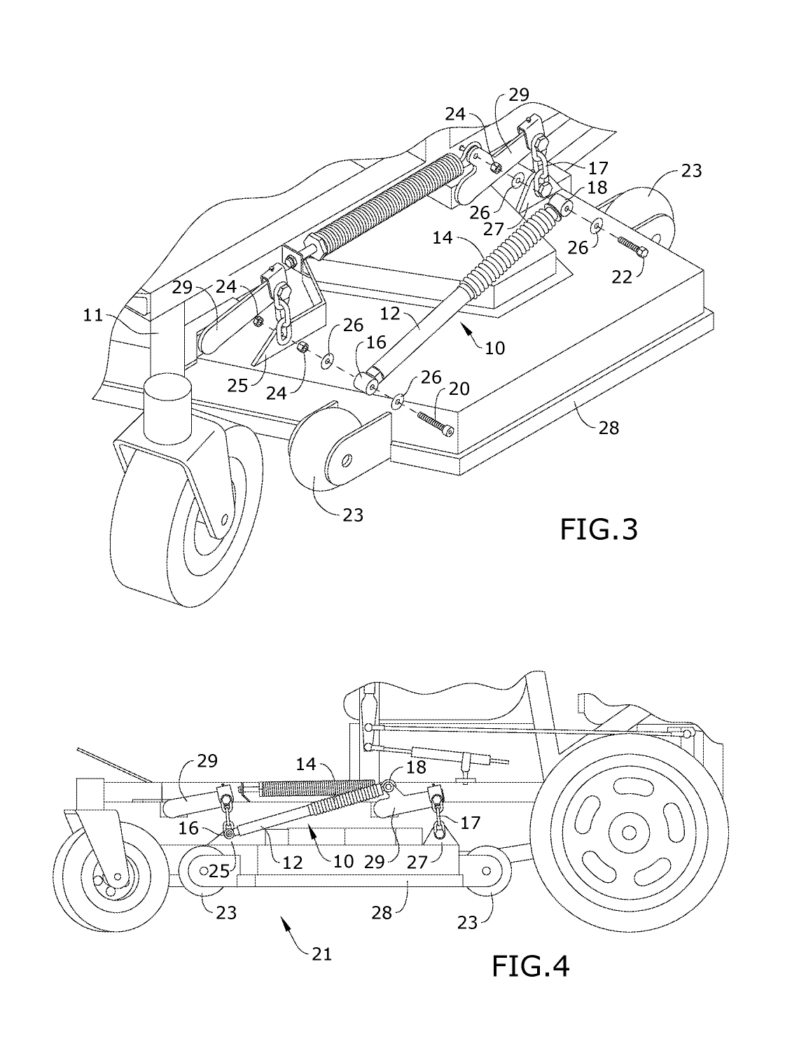

As illustrated in FIG. 3, the second end 16 may include an aperture. A bolt 20 may run through a washer 26 and the aperture, another washer 26, a nut 24 and through an aperture formed on the upper surface of the cutting deck 28. A nut 24 may secure to the end of the bolt 20, thereby securing the second end 16 to the cutting deck 28. The first end 18 may also include an aperture. A bolt 22 may run through a washer 26 and the aperture, another washer 26, a nut 24 and through an aperture formed through the mower frame 11. A nut 24 may secure to the end of the bolt 22, thereby securing the first end 18 to the mower frame 11.

It should be understood, of course, that the foregoing relates to exemplary embodiments of the invention and that modifications may be made without departing from the spirit and scope of the invention as set forth in the following claims.

What is claimed is:

1. A mower comprising:
a mower frame;
at least one drive motor supported by the mower frame;
a plurality of wheels supporting the mower frame, wherein at least one of the plurality of wheels is driven by the at least one drive motor;
a cutting deck assembly hanging from the mower frame by a plurality of chain links, the cutting deck assembly comprising a cutting deck and at least one cutting blade mounted under the cutting deck and rotatable by the at least one drive motor; and
at least one shock absorber comprising a first end opposite a second end, wherein the first end is secured to the mower frame and the second end is secured to the cutting deck.

2. The mower of claim 1, wherein the at least one shock absorber comprises a first shock absorber secured to a first side of the mower frame and the cutting deck and a second shock absorber secured to a second side of the mower frame and the cutting deck.

3. The mower of claim 1, wherein the shock absorber comprises a piston and a baffle.

4. The mower of claim 1, wherein the cutting deck comprises a plurality of cutting deck wheels.

5. The mower of claim 1, wherein the plurality of chain links comprises a pair of front chain links secured to front flanges of the cutting deck and a pair of rear chain links secured to rear flanges of the cutting deck.

6. The mower of claim 5, wherein the second end of the shock absorber is secured to one of the front flanges.

7. The mower of claim 5, wherein the second end of the shock absorber is secured to one of the rear flanges.

8. The mower of claim 1, wherein the chain links are secured to the mower frame by pivoting arms.

9. The mower of claim 8, wherein the first end of the shock absorber is secured to one of the pivoting arms.

10. The mower of claim 1, wherein the shock absorber is one of a mechanical shock absorber and a hydraulic shock absorber.
